(19) United States
(12) Patent Application Publication
(10) Pub. No.: US 2024/0356830 A1
(43) Pub. Date: Oct. 24, 2024

(54) A METHOD OF CONTROLLING A PERFORMANCE TEST IN AN ACCESS NETWORK

(71) Applicant: BRITISH TELECOMMUNICATIONS PUBLIC LIMITED COMPANY, London (GB)

(72) Inventors: David TOWNEND, London (GB); Malcolm HUBERT, London (GB)

(21) Appl. No.: 18/683,348

(22) PCT Filed: Jul. 13, 2022
(86) PCT No.: PCT/EP2022/069686

§ 371 Date: Feb. 13, 2024

(30) Foreign Application Priority Data
Aug. 27, 2021 (GB) 2112300.5

(51) Int. Cl. H04L 43/50; H04W 24/08

(52) U.S. Cl. CPC H04L 43/50; H04W 24/08

(57) ABSTRACT

This invention provides a method of operating a controller for controlling a performance test in one or more access networks, wherein a first access network of the one or more access networks includes a first access node, a first plurality of network nodes and a first communications medium, and each network node of the first plurality of network nodes is connected to the first access node by the first communications medium such that the first communications medium is shared by the first plurality of nodes, the method comprising the steps of: obtaining data identifying the first communications medium of a first network node of the first plurality of network nodes; determining that a count of concurrent performance tests of the first communications medium is less than a first threshold; and in response to the determination, causing initiation of a first performance test of the first communications medium in which the first network node is a participant of the first performance test. This invention further provides a method of operating a network node of a first plurality of network nodes in a first access network, the first access network including a first access node and a first communications medium, and each network node of the first plurality of network nodes is connected to the first access node by the first communications medium such that the first communications medium is shared by the first plurality of nodes, the method comprising the steps of: sending a performance test request message to a controller, the performance test request message identifying the first communications medium; and receiving a performance test response message from the controller; and in response to receiving the performance test response message, participating in the first performance test.

### FIELD OF THE INVENTION

The present invention relates to a method of controlling a performance test in an access network.

### BACKGROUND

A performance test may be conducted on an access network connection between an access node and a Customer Premises Equipment (CPE). These performance tests are typically conducted on a number of access network connections in a network operator's access network to collect data representative of customer experience of that access network. This data may then be used to diagnose the access network, indicate network performance to a customer, and/or to objectively compare performance of access networks of different network operators.

A conventional performance test system performs an automated suite of performance test measurements (such as a speed test) at random times during the day. These tests are typically performed when the access connection is deemed inactive (that is, the access connection is not in active use by the end user) to avoid a scenario in which data generated by the end user renders the test inaccurate (as data for the test and data for the end user would share the same access connection). However, where the access connection to the CPE is provided over a shared communications medium (wherein the shared communications medium may be a physical resource, such as a device or wired communications link, that is shared by a plurality of CPE, or may be a non-physical resource, such as electromagnetic spectrum, that is shared by a plurality of CPE), these conventional performance test systems do not account for data for other users communicated over the shared communications medium at the time of the performance test. This presents a problem. That is, if other CPEs of the shared communications medium are made artificially silent during a performance test, then the performance test is not representative of a real-world measurement and there may be a negative user experience for users of these other CPEs. Furthermore, it is also a recognised problem that too much monitoring traffic (such as traffic generated by these performance tests) active at the same time would also provide an unrealistic view of the access network because the results would not be representative of the ambient background traffic generated by other CPEs of the shared communications medium.

### SUMMARY OF THE INVENTION

According to a first aspect of the invention, there is provided a method of operating a controller for controlling a performance test in one or more access networks, wherein a first access network of the one or more access networks includes a first access node, a first plurality of network nodes and a first communications medium, and each network node of the first plurality of network nodes is connected to the first access node by the first communications medium such that the first communications medium is shared by the first plurality of nodes, the method comprising the steps of: obtaining data identifying the first communications medium of a first network node of the first plurality of network nodes; determining that a count of concurrent performance tests of the first communications medium is less than a first threshold; and in response to the determination, causing initiation of a first performance test of the first communications medium in which the first network node is a participant of the first performance test.

The step of determining that the count of concurrent performance tests of the first communications medium is less than the first threshold may be based on the count of performance tests of the first communications medium that are currently active.

The method may further comprise the step of: determining a first scheduled time for the first performance test, wherein the step of determining that the count of concurrent performance tests of the first communications medium is less than the first threshold may be based on the count of concurrent performance tests of the first communications medium at the first scheduled time, and the step of causing initiation of the first performance test may be such that the first performance test is conducted at the first scheduled time.

A second access network of the one or more access networks may be include a second access node, a second plurality of network nodes and a second communications medium, and each network node of the second plurality of network nodes may be connected to the second access node by the second communications medium such that the second communications medium is shared by the second plurality of nodes, wherein the first network node may be a member of the first plurality of network nodes and the second plurality of network nodes and the obtained data may further identify the second communications medium of the first network node, the method may further comprise the steps of: determining that a count of concurrent performance tests of the second communications medium is less than a second threshold; and in response to the determination, causing initiation of a second performance test of the second communications medium in which the first network node is a participant of the second performance test.

The step of determining that the count of concurrent performance tests of the second communications medium is less than the second threshold may be based on the count of performance tests of the second communications medium that are currently active.

The method may further comprise the step of: determining a second scheduled time for the second performance test, wherein the step of determining that the count of concurrent performance tests of the second communications medium is less than the second threshold may be based on the count of concurrent performance tests of the second communications medium at the second scheduled time, and the step of causing initiation of the second performance test may be such that the second performance test is conducted at the second scheduled time.

According to a second aspect of the invention, there is provided a method of operating a network node of a first plurality of network nodes in a first access network, the first access network including a first access node and a first communications medium, and each network node of the first plurality of network nodes is connected to the first access node by the first communications medium such that the first communications medium is shared by the first plurality of nodes, the method comprising the steps of: sending a performance test request message to a controller, the performance test request message identifying the first communications medium; and receiving a performance test response message from the controller; and in response to receiving the performance test response message, participating in the first performance test.

The performance test response message may indicate a first scheduled time for the first performance test, and the step of participating in the first performance test may be at the first scheduled time for the first performance test.

The network node may also be a member of a second plurality of network nodes, wherein the second plurality of network nodes are part of a second access network, the second access network including a second access node and a second communications medium, and each network node of the second plurality of network nodes is connected to the second access node by the second communications medium such that the second communications medium is shared by the second plurality of nodes, wherein the performance test request message further identifies the second communications medium, and the method may further comprise the step of: in response to receiving the performance test response message, participating in the second performance test.

The performance test response message may indicate a second scheduled time for the second performance test, and the step of participating in the second performance test may be at the second scheduled time for the second performance test.

According to a third aspect of the invention, there is provided a computer program comprising instructions which, when the program is executed by a computer, cause the computer to carry out the steps of either the first or second aspects of the invention. The computer program may be stored on a computer readable carrier medium.

According to a fourth aspect of the invention, there is provided a controller comprising a processor adapted to perform the method of the first aspect of the invention.

According to a fifth aspect of the invention, there is provided a network node comprising a processor adapted to perform the method of the second aspect of the invention.

### BRIEF DESCRIPTION OF THE FIGURES

In order that the present invention may be better understood, embodiments thereof will now be described, by way of example only, with reference to the accompanying drawings in which:

FIG. 1 is a schematic diagram illustrating a first and second access network of a first embodiment of the present invention;

FIG. 2 is a flowchart illustrating steps performed by a network node of the embodiment of FIG. 1 in a first embodiment of a method of the present invention; and

FIG. 3 is a flowchart illustrating steps performed by a performance test controller of the embodiment of FIG. 1 in the first embodiment of the method of the present invention.

### DETAILED DESCRIPTION OF EMBODIMENTS

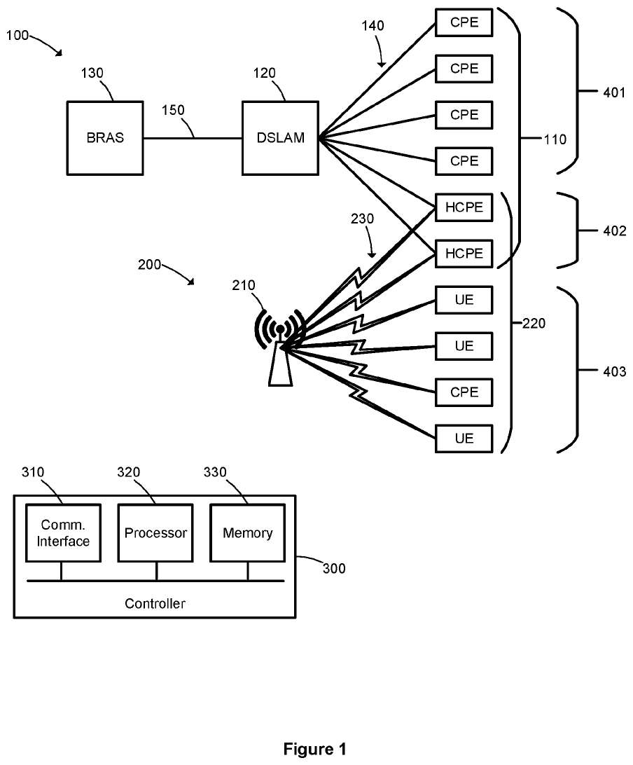

A first embodiment will now be described with reference to FIG. 1. FIG. 1 illustrates a first access network 100, a second access network 200 and a performance test controller 300. In this first embodiment, the first access network 100 is a wired access network based on a Digital Subscriber Line (DSL) infrastructure and includes a first plurality of network nodes designated by curly bracket having reference numeral 110, a DSL Access Multiplexer (DSLAM) 120, and a Broadband Remote Access Server (BRAS) 130. In this example, the first plurality of network nodes 110 includes Customer Premises Equipment (CPE) and Hybrid CPE (HCPE), which are discussed in more detail below. A first plurality of access connections 140 each connect a network node of the first plurality of network nodes 110 to the DSLAM 120, and a wired access connection 150 connects the DSLAM 120 to the BRAS 130. The wired access connection 150 is a shared communications medium of the first access network 100 such that data for all network nodes of the first plurality of network nodes is aggregated and communicated simultaneously via the wired access connection 150. In other words, a particular network node of the first plurality of network nodes 110 shares the same resources of the wired access connection 150 with all other network nodes of the first plurality of network nodes 110. The total resources of the wired access connection 150 may be less than that required to serve all network nodes of the first plurality of network nodes 110 at their maximum speed. The network nodes served by the wired access connection 150 may therefore be referred to as being members of a first contention domain as they must contend with other network nodes of the first plurality of network nodes for the resources of the wired access connection 150.

FIG. 1 also illustrates a second access network 200. In this first embodiment, the second access network 200 is a wireless wide area network such as a cellular network based on the 4^{th} Generation (4G) cellular telecommunications protocol as standardised by the 3^{rd} Generation Partnership Project (3GPP). The second access network 200 includes a base station 210 and a second plurality of network nodes designated by curly bracket having reference numeral 220. The second plurality of network nodes 220 includes HCPE, CPE and User Equipment (UE).

Each network node of the second plurality of network nodes 220 connects to the base station 210 via a wireless access connection of a plurality of wireless access connections 230. The plurality of wireless access connections 230 use a shared communications medium (that is, the Radio Frequency (RF) spectrum of the second access network 200) such that data for the second plurality of network nodes 220 is communicated simultaneously using the RF spectrum of the second access network 200. In other words, a particular network node of the second plurality of network nodes 220 shares the same resources of the RF spectrum of the second access network 200 with all other network nodes of the second plurality of network nodes 220. The total resources of the RF spectrum of the second access network 200 may be less than that required to serve all network nodes of the second plurality of network nodes 220 at their maximum speed. The network nodes served by this RF spectrum of the second access network 200 may therefore be referred to as being members of a second contention domain as they must contend with other network nodes of the second plurality of network nodes 220 for the resources of the RF spectrum of the second access network 200.

FIG. 1 further illustrates a first set of network nodes (designated by curly bracket having reference numeral 401) that are members of the first plurality of network nodes 110 only such that they are connected to the first access network 100 only (and therefore not connected to the second access network 200), a second set of network nodes (designated by curly bracket having reference numeral 402) that are members of the first plurality of network nodes 110 and the second plurality of network nodes 220 such that they are connected to both the first access network 100 and the second access network 200, and a third set of network nodes (designated by curly bracket having reference numeral 403) that are members of the second plurality of network nodes 220 only such that they are connected to the second access network 200 only (and therefore not connected to the first access network 100). The second set of network nodes 402 are all HCPE that may communicate with the first and second access network 100, 200. This communication to multiple access networks may be contemporaneous.

Each network node of the first, second and third sets of network nodes 401, 402, 403 stores (in memory) a contention domain identifier for the one or more contention domains it is a member of. In this first embodiment, each network node of the first set of network nodes 401 store a contention domain identifier for the first contention domain, each network node of the second set of network nodes 402 store a contention domain identifier for the first contention domain and a contention domain identifier for the second contention domain, and each network node of the third set of network nodes 403 store a contention domain identifier for the second contention domain. The contention domain identifier for the first contention domain may be a Medium Access Control (MAC) address of the BRAS port of the network node's first access connection, and the contention domain identifier for the second contention domain may be a combination of the Evolved Universal Mobile Telecommunications System Terrestrial Radio Access (E-UTRA) Cell Identity (ECI), the Physical Cell Identifier (PCI), and the E-UTRA Absolute Radio Frequency Number (EARFCN) of the network node's second access connection.

FIG. 1 also illustrates the performance test controller 300. The performance test controller 300 includes a communications interface 310, a processor 320 and memory 330. In this embodiment, the communications interface 310 is configured to communicate with each network node of the first, second and third sets of network nodes 401, 402, 403, such as to exchange performance test request and response messages with each network node of the first, second and third sets of UE 401, 402, 403. The processor 320 is configured to determine, based on one or more contention domain identifiers transmitted as part of the performance test request messages, whether a performance test may be conducted (as described in more detail below in the first embodiment of the method of the present invention). Memory 330 stores a value of a maximum number of concurrent performance tests that may be conducted for each contention domain.

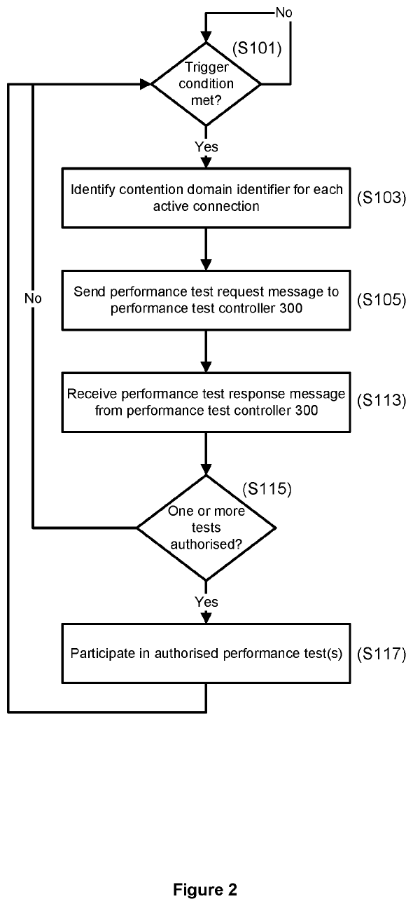

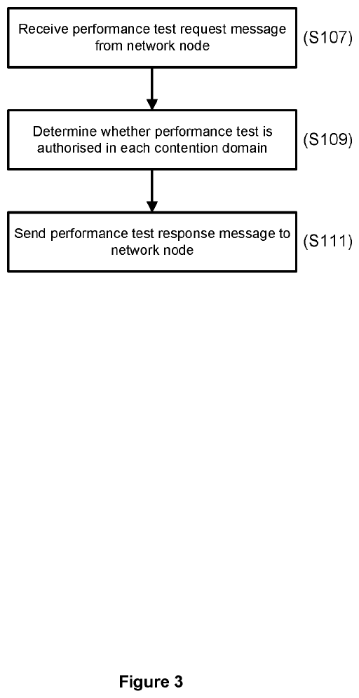

A first embodiment of a method of the present invention will now be described with reference to FIGS. 2 and 3. FIG. 2 illustrates the steps of this first embodiment carried out by a network node of the first, second or third sets of network nodes 401, 402, 403, and FIG. 3 illustrates the steps carried out by the performance test controller 300. In step S101, as shown in FIG. 2, the network node determines whether a trigger condition has been met. This trigger condition may be, for example, expiry of a configurable timer (e.g. 24 hours plus a random offset timer) since the last execution of this first embodiment. The network node therefore waits a predetermined time period before proceeding to step S103. In step S103, the network node determines the contention domain identifier for each active connection. In the example of a CPE of the first set of network nodes having an active connection for the first contention domain only, this identifier is the MAC address of the BRAS port the CPE is connected to. In the example of a HCPE of the second set of network nodes having an active connection for the first and second contention domains, these identifiers are the MAC address of the BRAS port of the first access connection for the HCPE and the ECI, PCI, EARFCN combination of the second access connection for the HCPE. In the example of a CPE or UE of the third set of network nodes having an active connection for the second contention domain only, this identifier is the ECI, PCI, EARFCN combination of the second access connection for the CPE or UE.

It is noted that, in the event the HCPE of the second set of network nodes 402 only has a single active connection for either of the first or second contention domains (despite being capable of maintaining multiple active connections), the HCPE would determine the contention domain identifier of that single active connection.

In step S105, the network node sends a performance test request message to the performance test controller 300. This request message includes the one or more contention domain identifiers determined in step S103.

Turning to FIG. 3, the performance test controller 300 receives the performance test request message in step S107. In step S109, the performance test controller 300 determines whether a count of concurrent performance tests for each of the one or more contention domains identified in the request message is below a threshold for that contention domain. In this first embodiment, this count is based on the number of performance tests that are currently being conducted (although other implementations are discussed below). The count of performance tests currently being conducted for a contention domain may be based on a count of all performance tests authorised by the performance test controller 300 in that contention domain that are currently being conducted. This includes any performance test in that contention domain that has previously been authorised and has been determined to be still active (for example, based on the time of the request and a known test duration, based on the performance test controller 300 actively participating in the performance test, or based on the performance test controller 300 determining that another entity is still participating in the performance test).

The threshold for each contention domain is configurable and may differ for contention domains based on different access network technologies. For example, the threshold for the first contention domain, based on DSL technology, may be higher than the threshold for the second contention domain, based on 4G cellular networking technology.

In a first example in which the request message is from a CPE of the first set of network nodes having an active connection for the first contention domain only, the performance test controller 300 determines whether a count of performance tests currently active in the first contention domain is below a threshold for the first contention domain. In a second example in which the request message is from an HCPE of the second set of network nodes having active connections to the first and second contention domains, the performance test controller 300 determines whether a count of performance tests currently active in the first contention domain is below a threshold for the first contention domain, and further determines whether a count of performance tests currently active in the second contention domain is below a threshold for the second contention domain. In a third example in which the request message is from a UE of the third set of network nodes having an active connection to the second contention domain only, the performance test controller 300 determines whether a count of performance tests currently active in the second contention domain is below a threshold for the second contention domain. In these examples, if the performance test controller 300 determines that a count of performance tests currently active in a contention domain is less than the threshold for that contention domain, then the performance test for that contention domain is authorised. If the performance test controller 300 determines that a count of performance tests currently active in a contention domain is not less (i.e. equal to or greater than) than the threshold for that contention domain, then the performance test for that contention domain is not authorised (i.e. it is rejected). In the second example in which the HCPE has active connections to a first and second contention domain, then these performance tests may be authorised and rejected independently (that is, the performance test for both contention domains may be authorised, the performance test for the first contention domain may be authorised and the performance test for the second contention domain may be rejected, the performance test for the first contention domain may be rejected and the performance test for the second contention domain may be authorised, and the performance test for both contention domains may be rejected).

In step S111, the performance test controller 300 sends a performance test response message to the network node from which it received the request in step S107. This response message includes the result of the determination in step S109 such that it indicates whether the performance test for each of the one or more contention domains is authorised.

Turning back to FIG. 2, in step S113, the network node receives the response message from the performance test controller 300. In step S115, the network node determines whether the response message indicates that one or more performance tests has been authorised by the performance test controller 300. If no performance tests have been authorised, then the method loops back to step S101. If one or more performance tests have been authorised then, in step S117, the network node initiates a performance test in each contention domain that has been authorised. The performance test may be conducted with the performance test controller 300 or another entity.

This first embodiment of the present invention therefore benefits in controlling the number of simultaneous tests being conducted over a shared communications medium to be less than a threshold amount. This threshold may be set such that these concurrent tests only generate a negligible amount of traffic relative to the overall capacity of the shared communications medium. In doing so, each of these performance tests that run simultaneously may be an accurate representation of real-world performance. In this context, a negligible amount of traffic is an amount that does not have a significant impact of the accuracy of the performance test. These thresholds may be configured through calibration for each technology type. Furthermore, these thresholds may be configured based on the particular performance test being conducted (which would therefore be indicated in the messaging between the network node and the performance test controller).

The process then loops back to step S101 such that the network node periodically requests performance tests for each of its contention domains.

In the above embodiment, the performance test controller 300 determines whether a count of performance tests currently active in the contention domain is below a threshold in order to authorise the requested performance test. However, in an alternative implementation, the performance test controller 300 may, in response to the performance test request message, schedule a time for each performance test of each contention domain such that the count of concurrent performance tests in each contention domain at the scheduled time of the performance test in that contention domain is less than the threshold. The performance test response message may then indicate the scheduled time for each performance test of each contention domain. The network node may then conduct the one or more performance tests at the respective scheduled times. This step may be substituted for step S109 in the first embodiment, or may be implemented as an additional step in the event the determination of S109 is that the count of performance tests currently active in a contention domain is not less than the threshold for that contention domain. In this implementation, step S115 may be redundant as the network node participates in all requested performance tests (at their respective scheduled times).

The skilled person will understand that the above embodiment may be applied to other forms of access network having a shared communications medium and therefore a contention domain. This includes, for example, a full optical fibre access network and a satellite access network. In examples where the network node is connected to a plurality of access networks, these access networks may be based on the same technology or based on different technologies.

The skilled person will understand that any form of performance test is applicable to embodiments of the present invention. In one implementation, the performance test may be to measure excess capacity on the shared communications medium of the access network (e.g. the excess capacity of the wired access connection between the DSLAM and BRAS in the first access network or the excess capacity of the shared RF spectrum of the second access network), which gives a reliable measurement of end-user customer experience.

The skilled person will understand that any other identifier that uniquely identifies a contention domain may be used. For example, for the DSL access network, any identifier that is a derivative of the BRAS's MAC address, such as the IPv6CP RemoteAccess identifier, may be used. Furthermore, the BRAS Chassis Name and Port ID may also be used (which is not normally visible to the CPE/HCPE, but may be obtained through request/response messaging with the BRAS).

The skilled person will also understand that it is non-essential for the network node to initiate the performance test on receipt of the response message. Instead, the performance test controller may initiate the test as soon as it has determined that the test is authorised.

The skilled person will understand that any combination of features is possible within the scope of the invention, as claimed.

1. A method of operating a controller for controlling a performance test in one or more access networks, wherein a first access network of the one or more access networks includes a first access node, a first plurality of network nodes and a first communications medium, and each network node of the first plurality of network nodes is connected to the first access node by the first communications medium such that the first communications medium is shared by the first plurality of nodes, the method comprising the steps of:
obtaining data identifying the first communications medium of a first network node of the first plurality of network nodes;
determining that a count of concurrent performance tests of the first communications medium is less than a first threshold; and
in response to the determination, causing initiation of a first performance test of the first communications medium in which the first network node is a participant of the first performance test.

2. A method as claimed in claim 1, wherein the step of determining that the count of concurrent performance tests of the first communications medium is less than the first threshold is based on the count of performance tests of the first communications medium that are currently active.

3. A method as claimed in claim 1, further comprising the step of:
determining a first scheduled time for the first performance test,
wherein the step of determining that the count of concurrent performance tests of the first communications medium is less than the first threshold is based on the count of concurrent performance tests of the first communications medium at the first scheduled time, and the step of causing initiation of the first performance test is such that the first performance test is conducted at the first scheduled time.

4. A method as claimed in claim 1, wherein a second access network of the one or more access networks includes a second access node, a second plurality of network nodes and a second communications medium, and each network node of the second plurality of network nodes is connected to the second access node by the second communications medium such that the second communications medium is shared by the second plurality of nodes, wherein the first network node is a member of the first plurality of network nodes and the second plurality of network nodes and the obtained data further identifies the second communications medium of the first network node, the method further comprising the steps of:
determining that a count of concurrent performance tests of the second communications medium is less than a second threshold; and
in response to the determination, causing initiation of a second performance test of the second communications medium in which the first network node is a participant of the second performance test.

5. A method as claimed in claim 4, wherein the step of determining that the count of concurrent performance tests of the second communications medium is less than the second threshold is based on the count of performance tests of the second communications medium that are currently active.

6. A method as claimed in claim 4, further comprising the step of:
determining a second scheduled time for the second performance test,
wherein the step of determining that the count of concurrent performance tests of the second communications medium is less than the second threshold is based on the count of concurrent performance tests of the second communications medium at the second scheduled time, and the step of causing initiation of the second performance test is such that the second performance test is conducted at the second scheduled time.

7. A computer program comprising instructions which, when the program is executed by a computer, cause the computer to carry out the steps of claim 1.

8. A computer readable carrier medium comprising the computer program of claim 7.

9. A controller comprising a processor adapted to perform the method claim 1.
